(19) United States
(12) Patent Application Publication
(10) Pub. No.: US 2010/0020006 A1
(43) Pub. Date: Jan. 28, 2010

(54) DISPLAY DEVICE AND ELECTRONIC EQUIPMENT

(75) Inventor: Natsuki Otani, Kanagawa (JP)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(73) Assignee: SONY CORPORATION, Tokyo (JP)

(21) Appl. No.: 12/503,452

(22) Filed: Jul. 15, 2009

(30) Foreign Application Priority Data
Jul. 24, 2008 (JP) 2008-191321

(51) Int. Cl. G09G 3/36

(52) U.S. Cl. 345/102

(57) ABSTRACT

Disclosed herein is a display device, including: a first photosensor section; second photosensor section; and signal processing section, wherein the light-shielding film is formed in the same layer as that on the substrate having a light-shielding function so as to be associated with the light-receiving element of the second photosensor section.

### BACKGROUND OF THE INVENTION

1. Field of the Invention

The present invention relates to a display device having photosensors in its display pixel section and frame region around the display surface and electronic equipment using the same.

2. Description of the Related Art

A technique is known which ensures higher screen brightness under high ambient illumination and lower screen brightness under low ambient illumination by detecting the illumination of external light with photosensors. This technique not only provides an easy-to-view screen. The technique also contributes to reduced power consumption of the backlight system as in the case of a liquid crystal display device which displays an image with a backlight. Further, the technique contributes to prolonged battery life for mobile applications such as mobile phone. As a result, a variety of techniques of this kind are under study.

On the other hand, several techniques have been proposed which are designed to provide a display device itself with a coordinate input function. More specifically, for example, display devices using a pressure-sensitive touch panel (refer to Japanese Patent Laid-Open No. 2002-149085 and Japanese Patent Laid-Open No. 2002-41244) and an electromagnetic induction touch panel (refer to Japanese Patent Laid-Open No. Hei 11-134105) are known.

However, the above display devices having a coordinate input function are difficult to reduce in size, thus resulting in higher cost as compared to ordinary display devices. Recent years have therefore seen the brisk development of display devices designed to solve the above problem. Such devices have a light-receiving element in each of the pixels so as to detect light incident on the light-receiving element (refer to Patent Documents Japanese Patent Laid-Open No. 2004-318067 and Japanese Patent Laid-Open No. 2004-318819).

A display device which permits coordinate input by providing light-receiving elements is advantageous over its counterpart having a coordinate input function not only in that the device can be downsized for reduced cost but also in that multi-coordinate input and area input are also possible.

### SUMMARY OF THE INVENTION

Incidentally, this kind of display device develops various sorts of characteristic drifts in photosensors. A way to cancel out such characteristic drifts would be to provide a reference light-receiving element having exactly the same structure as the photosensor on the position where light is not irradiated so as to determine the difference in output between the photosensor and reference element.

The reference light-receiving element (photosensor) must sufficiently shield external light. However, the traditional measure used to ensure such shielding of light was by, at best, depositing a black resist on the color filter side substrate opposed to the TFT substrate. This has caused stray light from the cell to fall on the element, resulting in noise.

It is an embodiment of the present invention to provide a display device which can sufficiently shield external light from falling on the reference light-receiving element for reduced noise effect and improved S/N ratio of a light-receiving system and electronic equipment having the same.

A display device according to a first embodiment of the present invention includes first and second photosensor sections and a signal processing section. The first photosensor section includes a light-receiving element on a substrate and detects the intensity of external light in the display region. The second photosensor section includes a light-receiving element on the substrate and has a light-shielding film disposed in the optical path to the light-receiving element. The signal processing section performs signal processing to determine the difference in detection signal between the first and second photosensor sections. The light-shielding film is formed in the same layer as that on the substrate having a light-shielding function so as to be associated with the light-receiving element of the second photosensor section.

The light-receiving element of the second photosensor section should preferably be formed with a thin film transistor or PIN diode. The light-receiving element has its electrodes connected to an overlying wiring layer. The light-shielding film should preferably be formed in the same layer and with the same member as the overlying wiring layer.

The display device should preferably have a backlight adapted to irradiate display light on the display region. The gate electrode of the thin film transistor or PIN (p-intrinsic-n) diode should preferably be formed closer to the backlight than the light-receiving portion of the light-receiving element and have a light-shielding function.

The surface luminance of the display region should preferably be variable. The signal processing section should preferably change the surface luminance of the display section according to the result of signal processing adapted to determine the difference in detection signal between the first and second photosensor sections.

The display device should preferably have a backlight adapted to irradiate display light on the display region. The signal processing section should preferably control the level of display light from the backlight.

The first photosensor section should preferably be able to detect light reflected from an object. The signal processing section should preferably output a signal to indicate whether there is any object in front of the first photosensor section according to the result of signal processing adapted to determine the difference in detection signal between the first and second photosensor sections.

A second embodiment of the present invention is electronic equipment having a display device. The display device includes first and second photosensor sections and a signal processing section. The first photosensor section includes a light-receiving element on a substrate and detects the intensity of external light in the display region. The second photosensor section includes a light-receiving element on the substrate and has a light-shielding film disposed in the optical path to the light-receiving element. The signal processing section performs processing to determine the difference in detection signal between the first and second photosensor sections. The light-shielding film is formed in the same layer as that having a light-shielding function so as to be associated with the light-receiving element of the second photosensor section.

According to the embodiments of the present invention, a light-shielding film formed on the substrate on which the light-receiving element of the second photosensor section is provided shields external light. The signal processing section performs signal processing to determine the difference in detection signal between the first and second photosensor sections. The signal resulting from the processing keeps the effect of reflected noise in the first photosensor section and dark current and offset noise during light shielding to an extremely low level.

The present invention can sufficiently shield the reference light-receiving element from external light, thus keeping down the effect of noise and providing improved S/N ratio of the light-receiving system.

### BRIEF DESCRIPTION OF THE DRAWINGS

FIG. 1 is a block diagram illustrating a configuration example of a liquid crystal display device according to an embodiment of the present invention;

FIGS. 2A to 2C are views illustrating a configuration example of an effective pixel region of the liquid crystal display device shown in FIG. 1;

FIG. 3 is a circuit diagram illustrating a configuration example of a photodetection section according to the present embodiment;

FIG. 4 is a sectional view illustrating a structural example in which photosensors (light-receiving elements) of first and second photosensor sections are formed with TFTs;

FIG. 5 is a plan view of the second photosensor section;

FIGS. 6A to 6G are a first set of diagrams illustrating manufacturing process steps of the second photosensor section;

FIGS. 7H to 7K are a second set of diagrams illustrating manufacturing process steps of the second photosensor section;

FIGS. 8A and 8B are diagrams illustrating an example of forming the light-receiving element of the photosensor section with a PIN diode;

FIG. 9 is a block diagram illustrating another configuration example of the liquid crystal display device according to the embodiment of the present invention;

FIG. 10 is a diagram schematically illustrating a detection system of light reflected from a backlight;

FIG. 11 is a schematic diagram illustrating an example of a flat module;

FIG. 12 is a perspective view illustrating a television set to which the present embodiment is applied;

FIGS. 13A and 13B are perspective views illustrating a digital camera to which the present embodiment is applied;

FIG. 14 is a perspective view illustrating a laptop personal computer to which the present embodiment is applied;

FIG. 15 is a perspective view illustrating a video camcorder to which the present embodiment is applied;

FIGS. 16A to 16G are views illustrating a personal digital assistant such as mobile phone to which the present embodiment is applied;

FIG. 17 is a block diagram illustrating the configuration of a display/imaging device according to the present embodiment;

FIG. 18 is a block diagram illustrating a configuration example of an I/O display panel shown in FIG. 17;

FIG. 19 is a circuit diagram illustrating a configuration example of a pixel;

FIG. 20 is a circuit diagram for describing the connection relationship between each pixel and H sensor readout driver; and

FIG. 21 is a timing diagram for describing the relationship between the backlight ON/OFF status and display status.

### DETAILED DESCRIPTION OF THE PREFERRED EMBODIMENTS

The preferred embodiments of the present invention will be described below with reference to the accompanying drawings.

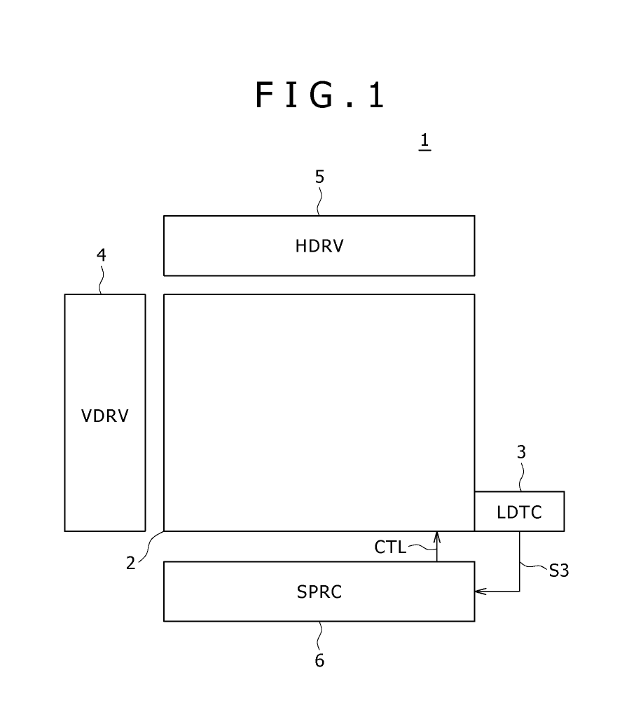

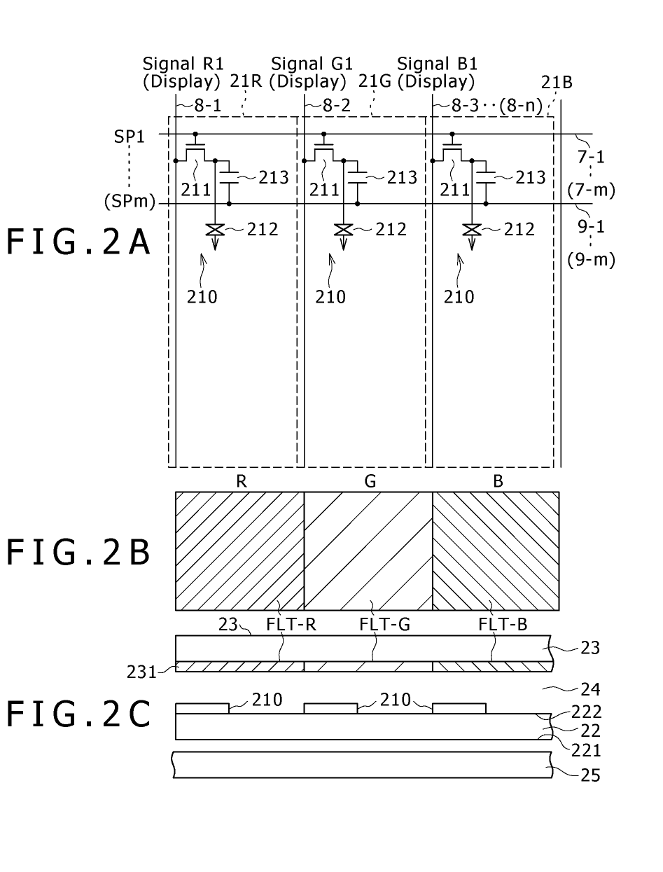

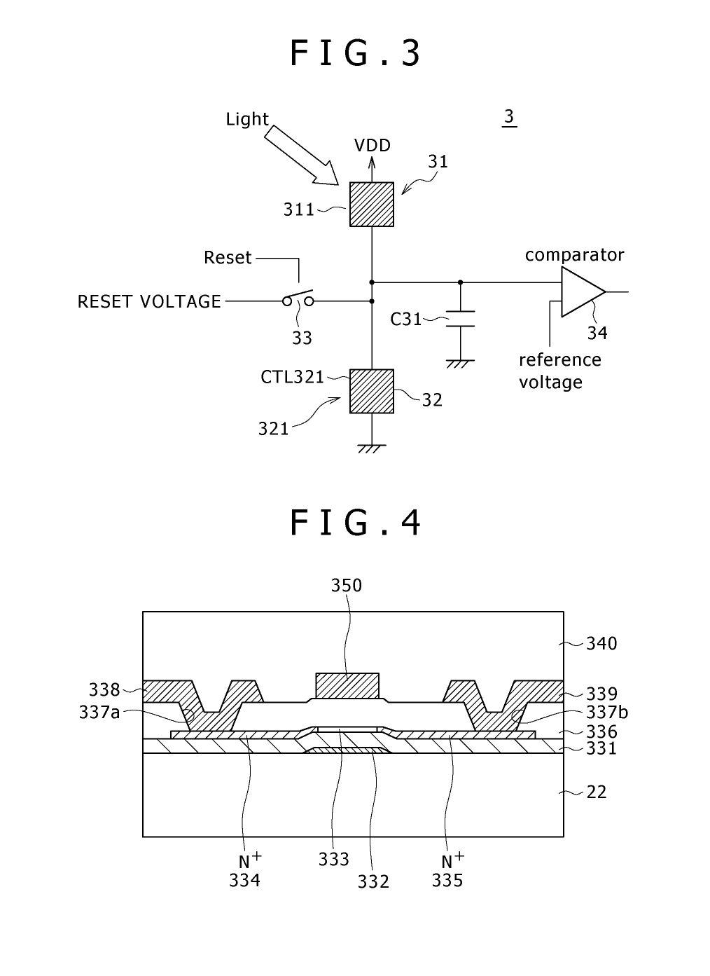

FIG. 1 is a block diagram illustrating a configuration example of a liquid crystal display device according to an embodiment of the present invention. FIGS. 2A to 2C are views illustrating a configuration example of an effective display region of the liquid crystal display device shown in FIG. 1. FIG. 2A illustrates the matrix arrangement of cells. FIG. 2B is a plan view of the cells. FIG. 2C is a sectional view of the cells. FIG. 3 is a view illustrating a configuration example of a photodetection circuit according to the present embodiment.

A liquid crystal display device 1 includes, as illustrated in FIG. 1, an effective display region section (image display section) 2 which serves as a display section, photodetection section (LDTC) 3, vertical drive circuit (VDRV) 4, horizontal drive circuit (HDRV) 5 and signal processing circuit (SPRC) 6.

The liquid crystal display device 1 according to the present embodiment is configured so that the surface luminance of the effective display region section 2 can be changed, for example, according to the intensity (illumination) of external light (actually the emission brightness of a backlight 25 can be changed). That is, the liquid crystal display device 1 according to the present embodiment has, for example, a light adjustment function.

The effective display region section 2 has a plurality of display cells 21 arranged in a matrix form. Each of the display cells 21 includes a display circuit which forms a display pixel. The effective display region section 2 forms a display screen. The photodetection section 3 is provided adjacent (in proximity) to the effective display region section 2. It should be noted that the photodetection section 3 may be formed integrally with the effective display region section 2 rather than in a region external and adjacent to the effective display region section 2 (in a non-display region outside the effective display region).

The photodetection section 3 includes first and second photosensor sections 31 and 32, a reset switch 33, comparator 34 and capacitor C31 as illustrated in FIG. 3.

The first photosensor section 31 includes a light-receiving element (photosensor) 311 and detects the intensity of external light in the effective display region section 2. The second photosensor section 32 includes a light-shielding-side sensor 321 which serves as a light-receiving element. A light-shielding film CTL321, formed with the same metal (e.g., Al) as the wiring, is disposed in the optical path to the light-receiving element 321 so as to sufficiently shield external light. It should be noted that the material of the light-shielding film is not limited to that of the wiring layer. Instead, the light-shielding film may be formed with the metal layer of the pixel electrode or other film having a light-shielding property provided on the TFT substrate.

It should be noted that the first and second photosensor sections 31 and 32 are provided where no light-shielding object (e.g., user's finger) is placed over the first and second photosensor sections 31 and 32 and where external light can be received for detection of the level thereof.

In the photodetection section 3 shown in FIG. 3, the photosensor 311 of the first photosensor section 31 and the light-shielding-side sensor 321 of the second photosensor section 32 are provided close (in proximity) to each other and connected in series between a power source potential VDD and reference potential VSS (e.g., ground potential GND). The photodetection section 3 compares the signal, obtained by removing the current component (e.g., dark current component) detected by the light-shielding-side sensor 321 of the second photosensor section 32 from the current component detected by the photosensor 311 of the first photosensor section 31, with the reference voltage using the comparator 34, thus obtaining an external light intensity signal. The photodetection section 3 outputs the obtained signal to the signal processing circuit 6 as a detection signal S3. The detection signal S3 from the photodetection section 3 is free from the infrared component detected by the photosensor 311. As described above, the photodetection section 3 has the capability to function as a signal processing section adapted to determine the difference in detection signal between the first and second photosensor sections.

Further, the signal processing circuit 6 controls the amount of light supplied to the effective display region section 2, for example, according to the detection signal S3 from the photodetection section 3. In the present embodiment, the signal processing circuit 6 changes the surface luminance of the effective display region section (screen display section) 2 using a control signal CTL according to the output level of the detection signal S3 from the photodetection section 3.

Now the description returns to the effective display region section 2. For example, red, green and blue display cells 21R, 21G and 21B associated with the three primary colors are arranged from left to right in FIG. 2A in a given region within the effective display region section 2. This arrangement is repeated via or not via an unshown light-shielding mask (black mask).

Further, in the effective display region section 2, red, green and blue filters FLT-R, FLT-G and FLT-B are formed respectively in the regions where the red, green and blue display cells 21R, 21G and 21B are arranged, as illustrated in FIG. 2B.

In the effective display region section 2, a liquid crystal layer 24 is sealed between a TFT substrate (first transparent substrate) 22 and opposed substrate (second transparent substrate) 23, as illustrated in FIG. 2C. These substrates are made, for example, of glass. Further, a backlight 25 is provided on the side of a bottom surface 221 of the TFT substrate 22. Still further, a display circuit 210 is formed for each of the display cells 21 on a base surface 222 of the TFT substrate 22. On the other hand, the filters FLT-R, FLT-G and FLT-B are formed on a base surface 231 of the opposed substrate 23.

The display circuit 210 of each of the display cells 21 has a thin film transistor (TFT) 211 as a switching element as illustrated in FIG. 2A. The display circuit 210 includes a liquid crystal cell (LC) 212 and holding capacitance (Cs) 213. The liquid crystal cell (LC) 212 has its pixel electrode connected to the drain electrode (or source electrode) of the TFT 211. The holding capacitance (Cs) 213 has one of its electrodes connected to the drain electrode of the TFT 211.

Scan lines (gate lines) 7-1 to 7-m are disposed in the pixel arrangement direction, one for each row of the display cells 21. Display signal lines 8-1 to 8-n are disposed in the pixel arrangement direction, one for each column of the display cells 21. The gate electrodes of the TFTs 211 of the display cells 21 in each row are connected to the same scan line (one of the scan lines (gate lines) 7-1 to 7-m). Further, the source electrodes (or drain electrodes) of the TFTs 211 of the display cells 21 in each column are connected to the same display signal line (one of the display signal lines 8-1 to 8-n).

In the configuration shown in FIG. 2A, the scan lines 7-1 to 7-m are connected to and driven by the vertical drive circuit 4. On the other hand, the display signal lines 8-1 to 8-n, disposed to be associated with the display cells 21, are connected to and driven by the horizontal drive circuit 5.

Further, in a common liquid crystal display device, pixel holding capacitance wirings (Cs) 9-1 to 9-m are disposed independently. A holding capacitance 213 is formed between each of the pixel holding capacitance wirings 9-1 to 9-m and connection electrode. Still further, a given DC voltage is supplied, as a common voltage VCOM, to the opposed electrode of the liquid crystal cell 212 of each of the display cells 21 in each of pixel sections 20 and/or to the other electrode of the holding capacitance 213 via a common wiring (shared wiring). Alternatively, the common voltage VCOM, whose polarity is inverted every horizontal scan period (1H), is, for example, supplied to the opposed electrode of the liquid crystal cell 212 of each of the display cells 21 and the other electrode of the holding capacitance 213.

The vertical drive circuit 4 performs a vertical scan (in the row direction) every field period in response to a vertical start signal VST, vertical clock VCK and enable signal ENB generated by an unshown clock generator. The vertical drive circuit 4 sequentially selects the display cells 21, connected to the scan lines 7-1 to 7-m, on a row-by-row basis. That is, when the vertical drive circuit 4 supplies a scan pulse SP1 to the scan line 7-1, the pixels in the first row are selected. When the vertical drive circuit 4 supplies a scan pulse SP2 to the scan line 7-2, the pixels in the second row are selected. Similarly, scan pulses SP3 to SPm are supplied respectively to the scan lines 7-3 to 7-m.

The horizontal drive circuit 5 generates a sampling pulse in response to a horizontal start pulse HST and horizontal clocks HCK generated by the unshown clock generator. The horizontal start pulse HST instructs the start of horizontal scan. The horizontal clocks HCK serve as a reference for horizontal scan and are opposite in phase to each other. The horizontal drive circuit 5 sequentially samples input image data R (red), G (green) and B (blue) in response to the generated sampling pulse and supplies these pieces of image data to the display signal lines 8-1 to 8-n as data signals to be written to the display cells 21.

A description will be given below in more detail of the configuration of the first and second photosensor sections 31 and 32 in the photodetection section 3.

FIG. 4 is a sectional view illustrating a structural example in which the photosensors (light-receiving elements) of the first and second photosensor sections are formed with TFTs.

A gate electrode 332, which is covered with a gate insulating film 331, is formed on the TFT substrate 22 (transparent insulating substrate made, for example, of glass). The gate electrode is formed, for example, by sputtering a metal such as molybdenum (Mo) or tantalum (Ta) or an alloy of such metals. On the gate insulating film 331 are formed a semiconductor film (I layer; channel forming region) 333 and a pair of n+ diffusion layers 334 and 335 (source and drain regions) on both sides of the semiconductor film 333. Further, an interlayer insulating film 336 is formed to cover the gate insulating film 331, semiconductor layer (channel forming region) 333 and n+ diffusion layers 334 and 335 (source and drain regions). The interlayer insulating film 336 is made, for example, of SiN or SiO2. A source electrode 338 is connected to the n+ diffusion layer 334 via a contact hole 337a formed in the interlayer insulating film 336. A drain electrode 339 is connected to the n+ diffusion layer 335 via a contact hole 337b formed in the interlayer insulating film 336. The source and drain electrodes 338 and 339 are formed by patterning, for example, aluminum (Al). A planarizing film 340 is formed on the interlayer insulating film 336 and source and drain electrodes 338 and 339. The liquid crystal layer 24 is formed on the planarizing film 340 when the planarizing film 340 is provided in the effective display region of the display region section or in the non-display region.

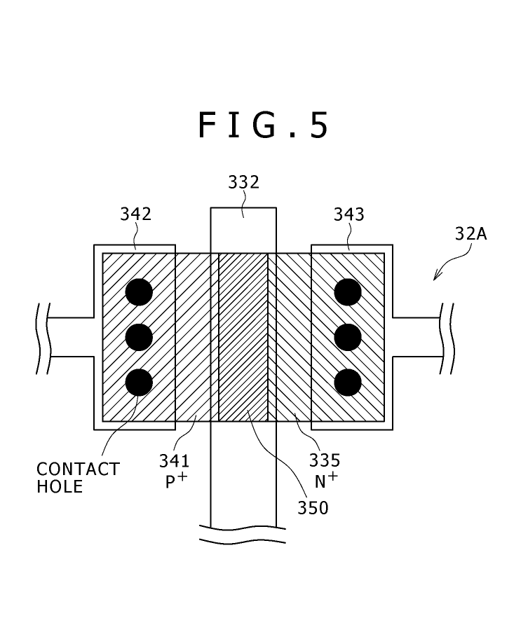

In the present embodiment, a light-shielding film 350, made of Al as used for the wiring, is, for example, formed in the optical path of external light incident upon the second photosensor section 32 and above the semiconductor film 333 which serves as an I layer or light-receiving portion, as illustrated in FIG. 4 so as to shield external stray light. FIG. 5 illustrates, for reference, a plan view of the second photosensor section 32.

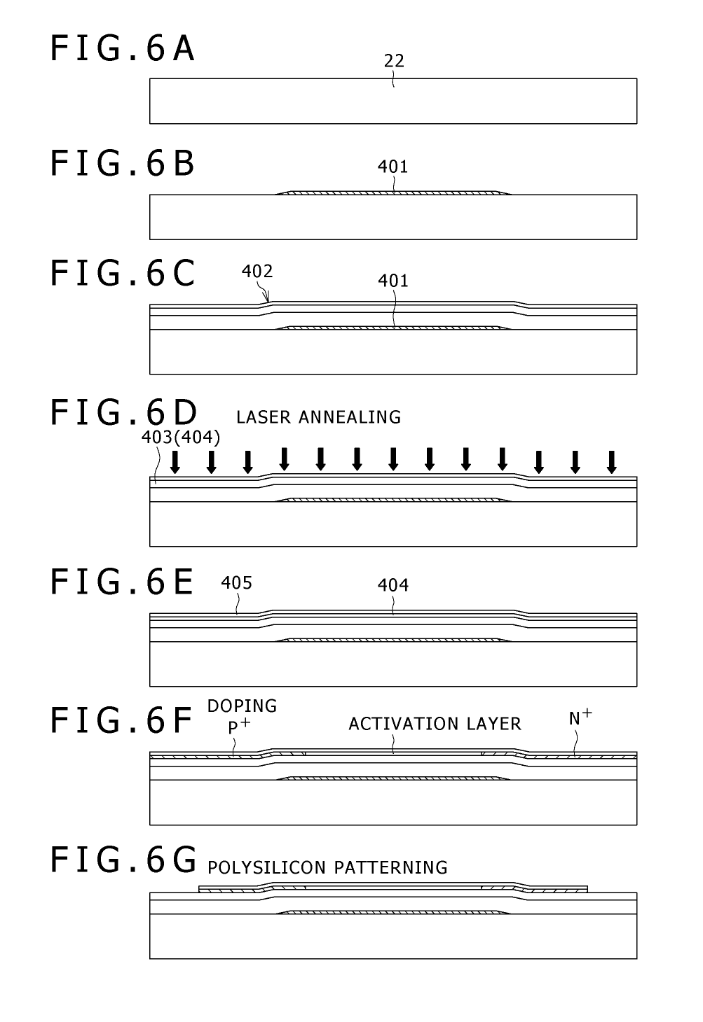

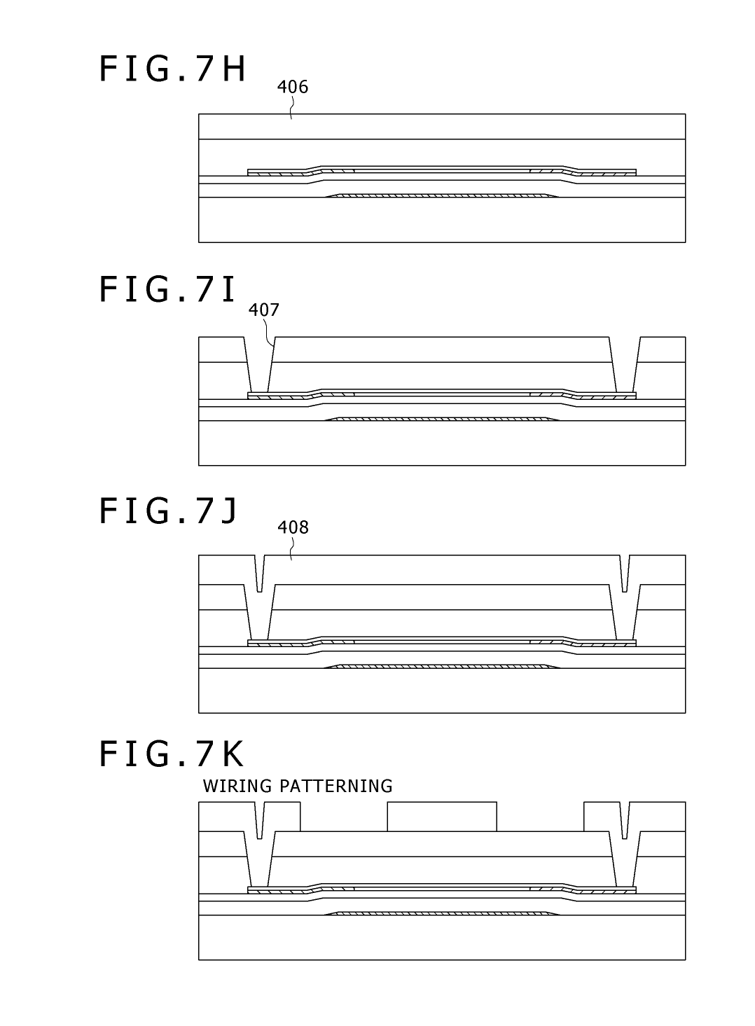

A description will be given below of the method of forming the second photosensor section having a light-shielding film made of the same layer as the wiring according to the present embodiment in relation to FIGS. 6A to 6G and FIGS. 7H to 7K.

As illustrated in FIGS. 6A and 6B, a gate electrode 401 is formed on the glass substrate 22, followed by the formation of a gate insulating film 402 on top thereof using a CVD system. The gate insulating film 402 has a laminated structure including, from the side of the glass substrate 22, SiN and SiO2 films. Next, as illustrated in FIG. 6D, an amorphous silicon 403 is formed on the gate insulating film 402, and then the amorphous silicon 403 is irradiated with excimer laser (laser-annealed) for polycrystallization of the silicon film. Next, the polycrystalline silicon film is doped using an ion injector to control the transistor threshold, followed by the formation of a SiO2 film 405 on the polycrystalline silicon film 404 using a CVD system as illustrated in FIG. 6E. Next, a resist is patterned by photolithography on the polycrystalline silicon film 404. Then, as illustrated in FIG. 6F, an anode and cathode are formed by an ion injector. This is followed by the removal of the resist from the substrate and annealing of the substrate in an annealing furnace for activation of the impurity. Next, as illustrated in FIG. 6G, a resist pattern is formed again, and the polycrystalline silicon film and SiO2 are patterned by a dry etcher. Next, as illustrated in FIG. 7H, an interlayer insulating film 406, made up of SiO2, SiN and SiO2 films, is formed using a CVD system, followed by the hydrogen termination of dangling bond contained in the crystalline silicon in an annealing furnace. Next, as illustrated in FIG. 7I, the resist is patterned by photolithography and etched to form a contact hole 407 that penetrates the polycrystalline silicon and gate electrode of the source and drain portions. Then, as illustrated in FIG. 7J, a metal film 408 made, for example, of Al is formed to serve as signal wirings, followed by the patterning of a light-shielding film together with the signal wirings by photolithography and etching as illustrated in FIG. 7K.

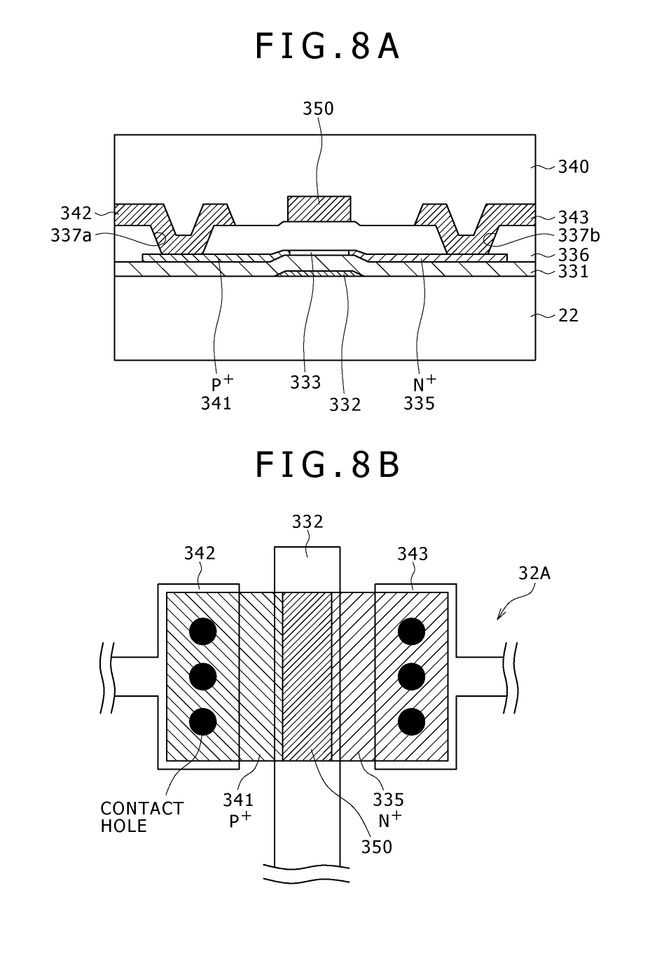

Although, in the above description, an example was given in which the light-receiving elements of the photosensor sections were formed with TFTs, the present invention is not limited thereto. Instead, the light-receiving elements may be formed with PIN diodes having a structure as illustrated in FIGS. 8A and 8B. It should be noted that, in FIGS. 8A and 8B, like components as those in FIGS. 4 and 5, are denoted by the same reference numerals to facilitate the understanding. The difference between the two is that a p+ diffusion layer 341 is formed instead of the n+ diffusion layer 334, an anode electrode 342 instead of the source electrode, and a cathode electrode 343 instead of the drain electrode.

In the photodetection section 3 configured as described above, the photosensor 311 of the first photosensor section 31 and the light-shielding-side sensor 321 of the second photosensor section 32 are provided close (in proximity) to each other and connected in series between the power source potential VDD and reference potential VSS (e.g., ground potential GND). In the photodetection section 3, external light irradiated onto the effective display region section 2 is received by the photosensor 311 of the first photosensor section 31. Then, the photodetection section 3 compares the signal, obtained by removing the dark current component or current component detected by the light-shielding-side sensor 321 of the second photosensor section 32 from the current component detected by the photosensor 311 of the first photosensor section 31, with the reference voltage using the comparator 34. The photodetection section 3 obtains the result of comparison as an external light intensity signal and outputs the obtained signal to the signal processing circuit 6 as the detection signal S3. The detection signal S3 from the photodetection section 3 is free from the infrared component detected by the photosensor 311. Then, the signal processing circuit 6 changes the surface luminance of the effective display region (screen display section) 2 using the control signal CTL according to the output level of the detection signal S3 from the photodetection section 3. For example, the signal processing circuit 6 controls the level of the display light from the backlight 25.

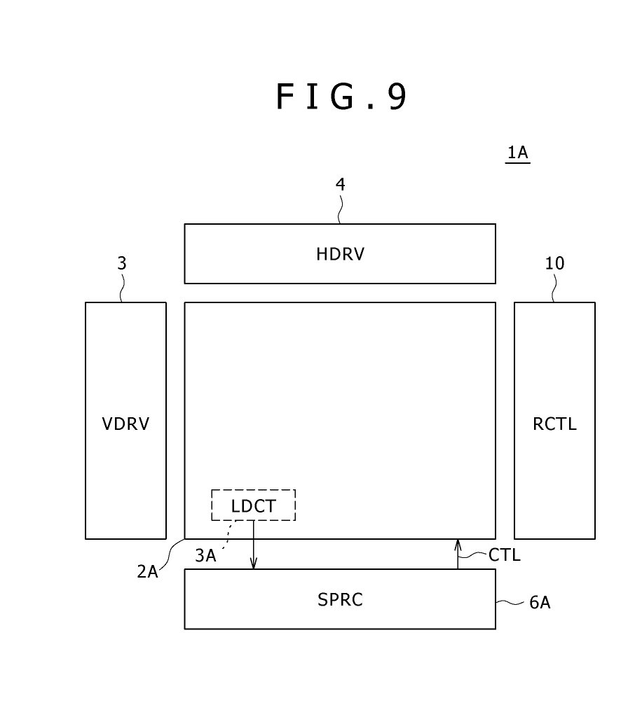

It should be noted that the photodetection section 3 may be formed integrally with the effective display region section 2 as illustrated in FIG. 9 rather than in a region external and adjacent to the effective display region section 2 (in a non-display region outside the effective display region). Other components and functions are basically the same as those in the previous embodiment, and therefore the detailed description thereof will be omitted.

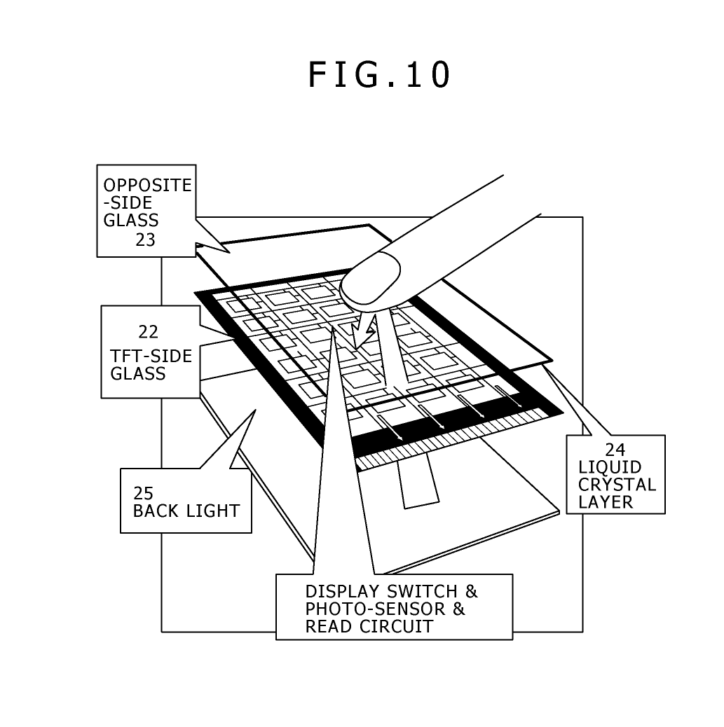

Further, a description was given above of the liquid crystal display device having a light adjustment function adapted to change the surface luminance of the effective display region sections 2, 2A and 2B according to the intensity (illumination) of external light (actually the emission brightness of the backlight 25 can be changed). However, the present invention is not limited to the light adjustment function, and is applicable to a detection system of light reflected from a backlight as shown in FIG. 10.

As described above, in the present embodiment, the photodetection section 3 includes the first and second photosensor sections 31 and 32. The first photosensor section 31 includes the photosensor 311 serving as a light-receiving element and detects the intensity of external light in the display region. The second photosensor section 32 has the light-shielding film CTL321 disposed in the optical path to the light-receiving element 321 serving as a light-receiving element. The photodetection section 3 has the capability to remove the component equivalent to at least the dark current component detected by the second photosensor section 32 from the output of the first photosensor section 31. The light-shielding film CTL321 is made of the same layer as the signal wirings. Therefore, the present embodiment provides the following advantageous effects.

That is, the present embodiment can, for example, as illustrated in FIG. 4, sufficiently shield external light from entering the reference light-receiving element of the second photosensor section 32 provided on the glass substrate 22. The present embodiment does so using the light-shielding film 350 (equivalent to the light-shielding film CTL321) provided on the glass substrate 22 to be associated with the light-receiving portion of the light-receiving element. This ensures reliable detection of the component attributable to the light-receiving element of the second photosensor section 32 and removes the component from the output of the first photosensor section 31, thus keeping down the effect of noise and providing improved S/N ratio of the light-receiving system. Further, no calibration operation is required at power-on, thus keeping down the effect of noise and providing improved S/N ratio of the light-receiving system. Still further, the light-shielding film can be formed in the process step for forming the signal wirings without adding any new process step for providing this film. Still further, the light-shielding film can be formed at the correct position using a high-accuracy TFT substrate (glass substrate 22) manufacturing process.

In a system using the above backlight or imaging system using external light, offset noise can be removed from the light-receiving elements (photosensors) and pixel circuits, thus providing a high S/N ratio. In a system using the above backlight or imaging system using external light, interference noise can be removed from the display, thus providing a high S/N ratio. Real-time cancellation of the noise provides a highly reliable system which is resistant to variations in temperature characteristics over time. For the same reason as given above, no calibration operation is required at power-on.

It should be noted that a light-receiving element may be provided for a plurality of pixels. Alternatively, a light-receiving element may be provided for each of red, green and blue. Still alternatively, a light-receiving element may be provided for each pixel. No specific mention is made of the arrangement of light-receiving elements in the display device to which the present invention is applied. As described above, application of the present invention to a display device incorporating light-receiving elements makes it possible to use light reception signals with minimum noise in post-processing. Further, the display signal can be prevented from mixing with the imaging signal during light reception (imaging).

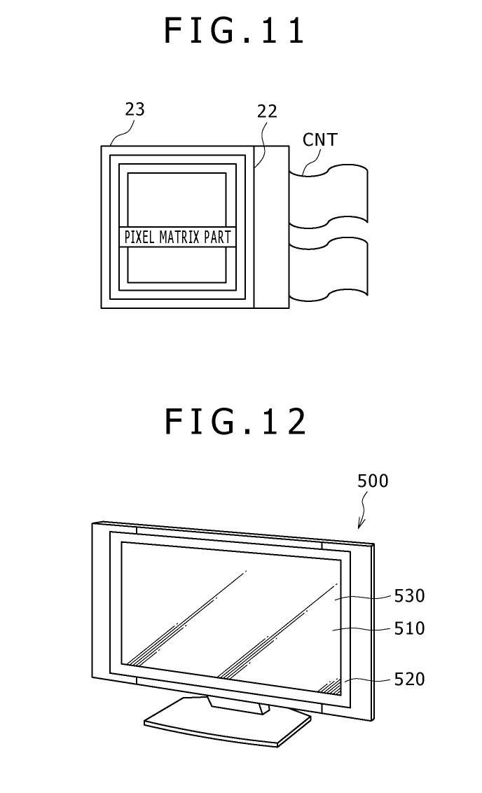

The display device according to the present embodiment includes a flat display device in a modular form as illustrated in FIG. 11. For example, a pixel array section is provided on the insulating substrate 22. The pixel array section has pixels integrated in a matrix. Each of the pixels includes a liquid crystal element, thin film transistor, thin film capacitance, light-receiving element and other components. An adhesive is applied around the pixel array section (pixel matrix section), after which an opposed substrate made of glass or other material is attached for use as a display module. This transparent opposed substrate 23 may have a color filter, protective film, light-shielding film and so on as necessary. An FPC (flexible printed circuit), adapted to allow exchange of signals or other information between external equipment and the pixel array section, may be provided as a connector CNT on the display module.

The aforementioned display device according to the present embodiment is applicable as a display of a wide range of electronic equipment including a digital camera, laptop personal computer, personal digital assistant such as mobile phone and video camcorder illustrated in FIGS. 12 to 16. These pieces of equipment are designed to display an image or video of a video signal fed to or generated inside the electronic equipment. Examples of electronic equipment to which the present embodiment is applied will be described below.

FIG. 12 is a perspective view illustrating a television set to which the present embodiment is applied. A television set 500 according to the present application example includes a video display screen section 510 made up, for example, of a front panel 520, filter glass 530 and other parts. The television set 500 is manufactured by using the display device according to the present embodiment as the video display screen section 510.

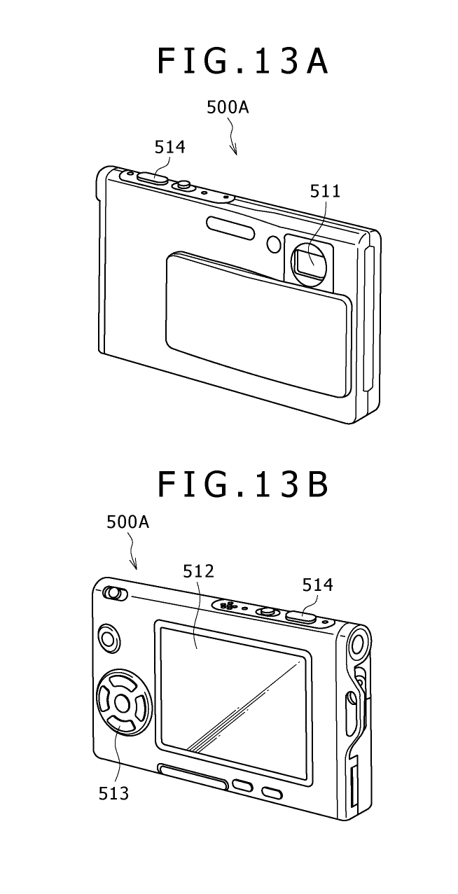

FIGS. 13A and 13B are perspective views illustrating a digital camera to which the present embodiment is applied. FIG. 13A is a perspective view of the digital camera as seen from the front, and FIG. 13B is a perspective view thereof as seen from the rear. A digital camera 500A according to the present application example includes a flash-emitting section 511, display section 512, menu switch 513, shutter button 514 and other parts. The digital camera 500A is manufactured by using the display device according to the present embodiment as the display section 512.

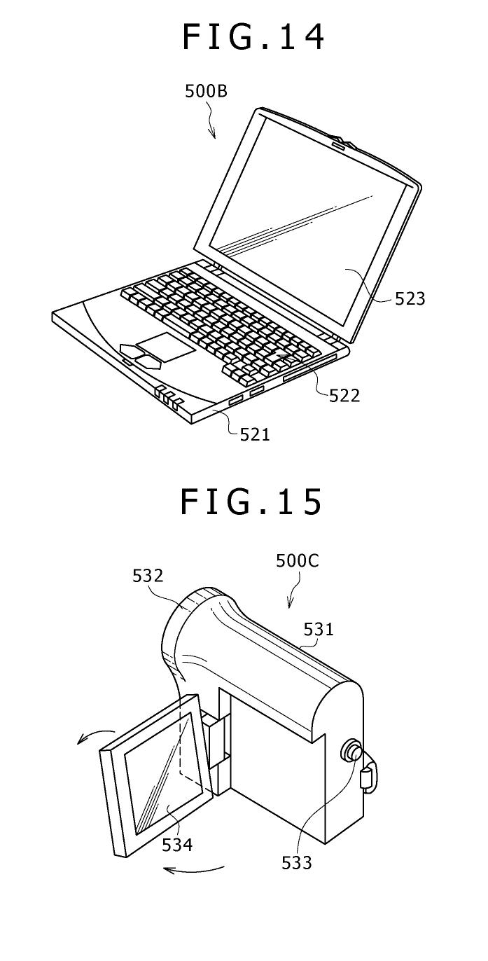

FIG. 14 is a perspective view illustrating a laptop personal computer to which the present embodiment is applied. A laptop personal computer 500B according to the present application example includes, in a main body 521, a keyboard 522 adapted to be manipulated for entry of text or other information, a display section 523 adapted to display an image, and other parts. The laptop personal computer 500B is manufactured by using the display device according to the present embodiment as the display section 523.

FIG. 15 is a perspective view illustrating a video camcorder to which the present embodiment is applied. A video camcorder 500C according to the present application example includes a main body section 531, lens 532 provided on the front-facing side surface to capture the image of the subject, imaging start/stop switch 533, display section 534 and other parts. The video camcorder 500C is manufactured by using the display device according to the present embodiment as the display section 534.

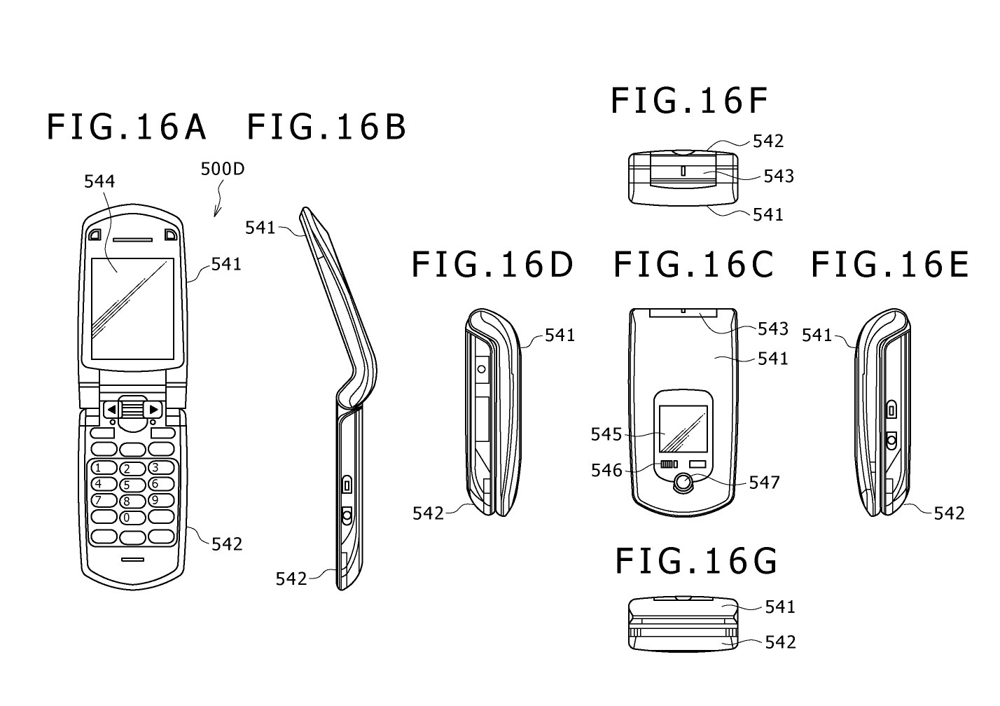

FIGS. 16A to 16G are perspective views illustrating a personal digital assistant such as mobile phone to which the present embodiment is applied. FIG. 16A is a front view of the mobile phone in an open position. FIG. 16B is a side view thereof. FIG. 16C is a front view of the mobile phone in a closed position. FIG. 16D is a left side view. FIG. 16E is a right side view. FIG. 16F is a top view. FIG. 16G is a bottom view. A mobile phone 500D according to the present application example includes an upper enclosure 541, lower enclosure 542, connecting section (hinge section in this example) 543, display 544, subdisplay 545, picture light 546, camera 547 and other parts. The mobile phone 500D is manufactured by using the display device according to the present embodiment as the display 544 and subdisplay 545.

The display device according to the present embodiment is also applicable to a display/imaging device as described below. This display/imaging device is applicable to the various types of electronic equipment described earlier.

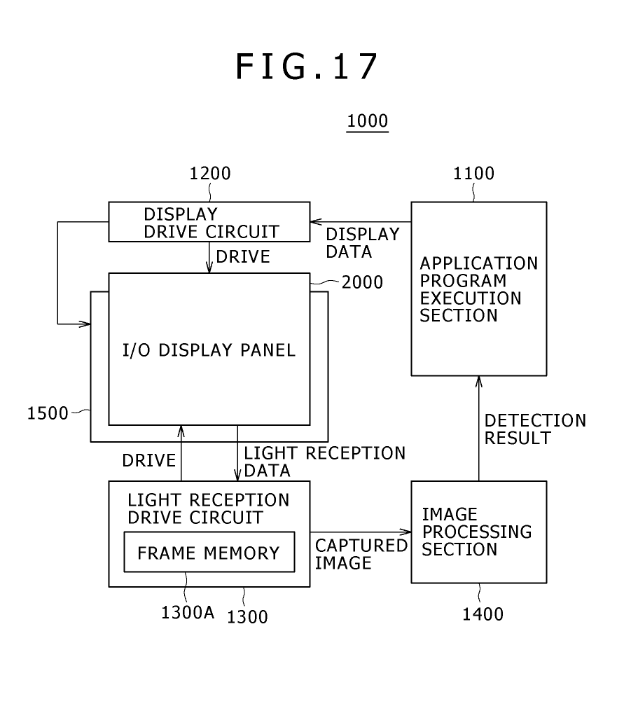

FIG. 17 illustrates the overall configuration of the display/imaging device. This display/imaging device includes an I/O display panel 2000, backlight 1500, display drive circuit 1200, light reception drive circuit 1300, image processing section 1400 and application program execution section 1100.

The I/O display panel 2000 includes a liquid crystal panel (LCD) having a plurality of pixels arranged in a matrix form over the entire surface. The I/O display 2000 is capable of displaying an image such as predetermined graphics and text based on display data as it is driven sequentially line by line (display capability). At the same time, the I/O display 2000 is capable of imaging an object in contact therewith or proximity thereto (imaging capability), as described later. On the other hand, the backlight 1500 is a light source of the I/O display panel 2000 and includes, for example, a plurality of light-emitting diodes. The backlight 1500 is designed to turn the light-emitting diodes on and off quickly at predetermined timings in synchronism with the operation timings of the I/O display panel 2000 as described later.

The display drive circuit 1200 drives the I/O display panel 2000 (sequentially drives the I/O display panel 2000 line by line) to display an image on the I/O display panel 2000 based on the display data (perform a display operation).

The light reception drive circuit 1300 drives the I/O display panel 2000 (sequentially drives the I/O display panel 2000 line by line) to obtain light reception data of the I/O display panel 2000 (to image the object). It should be noted that the light reception data of each pixel is stored in a frame memory 1300A, for example, on a frame-by-frame basis and output to the image processing section 1400 as a captured image.

The image processing section 1400 performs predetermined image processing (arithmetic operations) based on the captured image from the light reception drive circuit 1300 to detect and obtain information about the object in contact with or proximity to the I/O display panel 2000 (e.g., position coordinate data, object shape and size). It should be noted that this detection process will be described in detail later.

The application program execution section 1100 performs processing according to predetermined application software based on the detection result of the image processing section 1400. For example, among such processing is displaying the display data on the I/O display panel 2000 together with the position coordinates of the detected object. It should be noted that the display data generated by the application program execution section 1100 is supplied to the display drive circuit 1200.

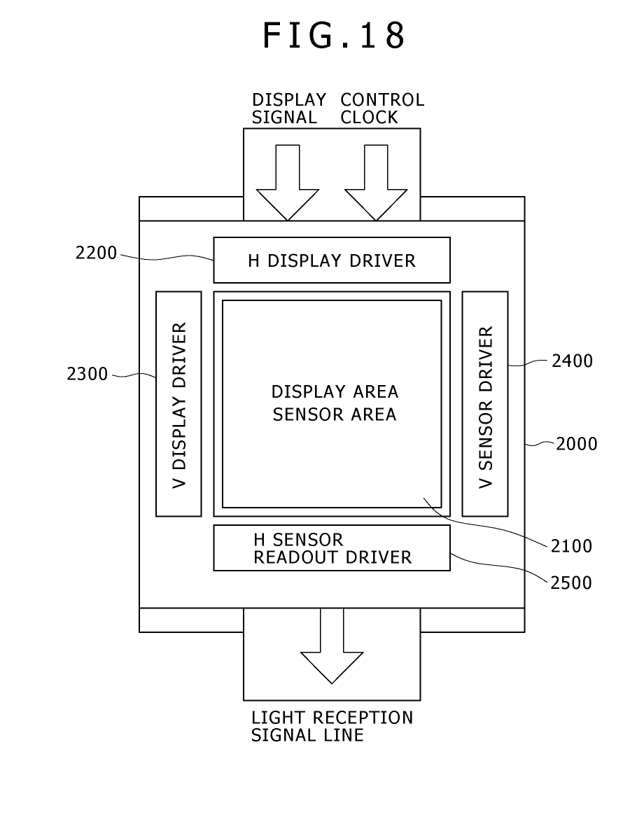

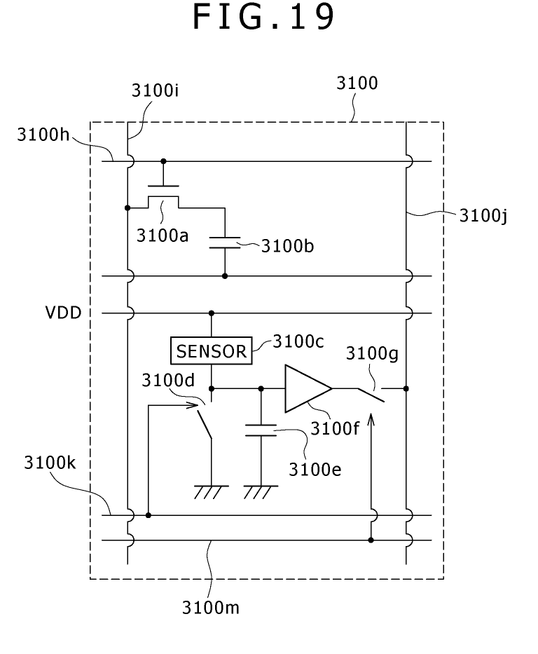

A description will be given next of a detailed example of the I/O display panel 2000 with reference to FIG. 18. The I/O display panel 2000 includes a display area (sensor area) 2100, H display driver 2200, V display driver 2300, H sensor readout driver 2500 and V sensor driver 2400.

The display area (sensor area) 2100 modulates light from the backlight 1500 to emit display light and also images an object in contact therewith or proximity thereto. In this area, the liquid crystal elements serving as the light-emitting elements (display elements) and light-receiving elements (imaging elements), which will be described later, are both arranged in a matrix form.

The H display driver 2200 sequentially drives, together with the V display driver 2300, the liquid crystal elements of the respective pixels in the display area 2100 line by line based on the display drive signal and control clock supplied from the display drive circuit 1200.

The H sensor readout driver 2500 sequentially drives, together with the V sensor driver 2400, the light-receiving elements of the respective pixels in the sensor area 2100 line by line to obtain a light reception signal.

A description will be given next of a detailed configuration example of the pixels in the display area 2100 with reference to FIG. 19. A pixel 3100 shown in FIG. 19 includes a liquid crystal element, serving as a display element, and a light-receiving element.

More specifically, on the side of the display elements, a switching element 3100a is provided at the intersection between a gate electrode 3100h extending in the horizontal direction and a drain electrode 3100i extending in the vertical direction. The switching element 3100a includes, for example, a thin film transistor (TFT). Further, a pixel electrode 3100b, which includes liquid crystal, is provided between the switching element 3100a and an opposed electrode. The switching element 3100a turns on and off based on the drive signal supplied via the gate electrode 3100h. A pixel voltage is applied to the pixel electrode 3100b based on the display signal supplied via the drain electrode 3100i when the switching element 3100a is on.

On the side of the light-receiving elements adjacent to the display elements, on the other hand, a light-receiving sensor 3100c is provided which includes, for example, a photodiode. The light-receiving sensor 3100c is supplied with the power source potential VDD. Further, a reset switch 3100d and capacitor 3100e are connected to the light-receiving sensor 3100c. The reset switch 3100d resets the light-receiving sensor 3100c. The capacitor 3100e stores the charge commensurate with the amount of light received. The stored charge is supplied to a signal output electrode 3100j via a buffer amplifier 3100f when a readout switch 3100g turns on. The stored charge will then be output externally. On the other hand, the ON/OFF operation of the reset switch 3100d is controlled by the signal from a reset electrode 3100k. The ON/OFF operation of the readout switch 3100g is controlled by the signal from a readout control electrode 3100m.

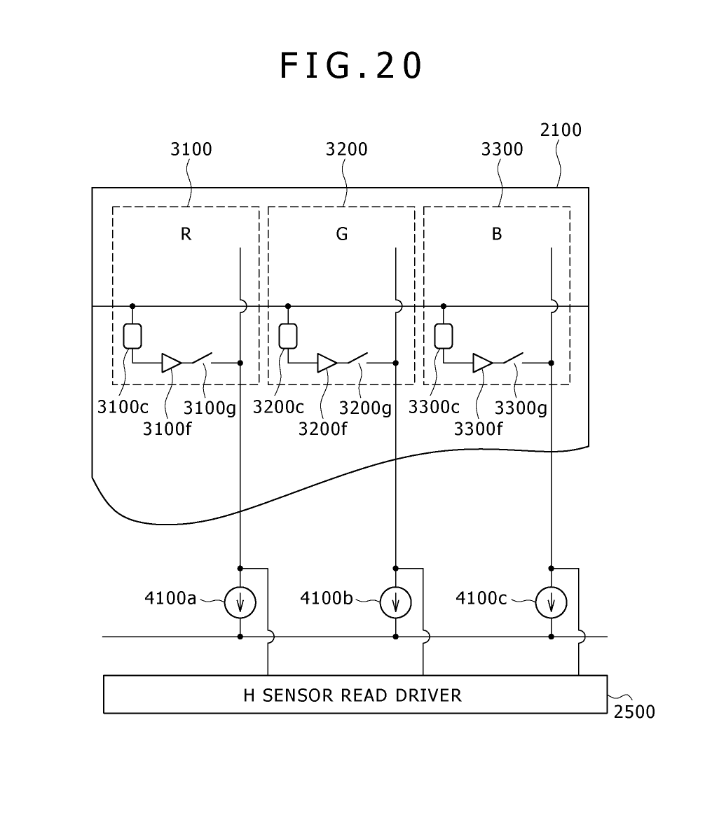

A description will be given next of the connection relationship between the pixels in the display area 2100 and the H sensor readout driver 2500 with reference to FIG. 20. In the display area 2100, red (R) pixel 3100, green (G) pixel 3200 and blue (B) pixel 3300 are arranged side by side.

The charges stored in the capacitors connected to light receiving elements 3100c, 3200c and 3300c of the respective pixels are amplified respectively by buffer amplifiers 3100f, 3200f and 3300f. These charges are supplied to the H sensor readout driver 2500 via the signal output electrode when readout switches 3100g, 3200g and 3300g turn on. It should be noted that constant current sources 4100a, 4200a and 4300a are connected to the signal output electrodes so that the horizontal sensor readout driver 2500 can detect the signal commensurate with the amount of light received with high sensitivity.

A detailed description will be given next of the operation of the display/imaging device.

A description will be given first of the basic operations of the display/imaging device, namely, the image display and object imaging operations.

In this display/imaging device, the display drive circuit 1200 generates a display drive signal based on the display data from the application program execution section 1100. This drive signal allows the I/O display panel 2000 to be sequentially driven line by line, thus allowing an image to be displayed. At this time, the backlight 1500 is also driven by the display drive circuit 1200, allowing the backlight 1500 to be lit up and extinguished in synchronism with the I/O display panel 2000.

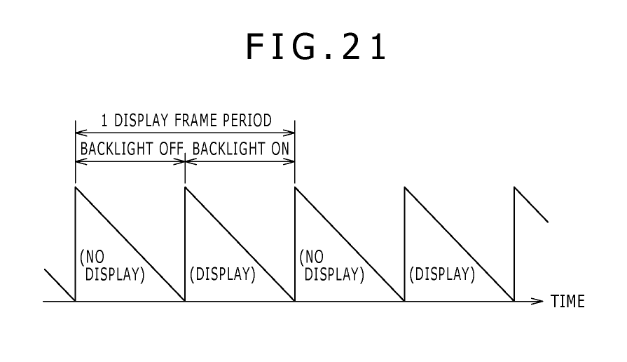

Here, a description will be given of the relationship between the ON/OFF status of the backlight 1500 and the display status of the I/O display panel 2000 in relation to FIG. 21. FIG. 21 shows the time on the horizontal axis and the vertical positions of the rows scanned for the light-receiving elements of the pixels to achieve imaging on the vertical axis.

First, when an image is displayed at a frame period of 1/60^{th} of a second, the backlight 1500 is unlit (off) during the first half of each frame period ( 1/120^{th} of a second) so that no image is displayed. On the other hand, the backlight 1500 is lit (on) during the second half of each frame period so that a display signal is supplied to the pixels and the image for that frame period is displayed.

As described above, the first half of each frame period is a non-lighting period during which no display light is emitted from the I/O display panel 2000. On the other hand, the second half of each frame period is a lighting period during which display light is emitted from the I/O display panel 2000.

Here, if there is an object (e.g., finger) in contact with or proximity to the I/O display panel 2000, this object will be imaged by the light-receiving elements of the pixels in the I/O display panel 2000 as the I/O display panel 2000 is sequentially driven by the light reception drive circuit 1300 line by line for light reception during the non-lighting and lighting periods. Then, a light reception signal is supplied from each of the light-receiving elements to the light reception drive circuit 1300. The light reception drive circuit 1300 stores one frame of the light reception signals of the pixels and outputs the signals to the image processing section 1400 as a captured image.

The image processing section 1400 performs predetermined image processing (arithmetic operations) based on the captured image to detect and obtain information about the object in contact with or proximity to the I/O display panel 2000 (e.g., position coordinate data, object shape and size).

As an example, the image processing section 1400 determines the difference in captured image between the non-lighting and lighting periods to remove external light, thus providing image information based on the light from the backlight 1500 reflected from the object in contact with or proximity to the I/O display panel 2000 during the lighting period. The data equal to or higher than the predetermined threshold is extracted from this image information for binarization. Then, the data is subjected, for example, to image processing to find the barycentric coordinates, thus providing information about the object in contact with or proximity to the I/O display panel 2000.

On the other hand, if infrared light is emitted for detection purposes together with visible light from the backlight 1500, the infrared component may be turned on and off while leaving the visible light component lit constantly.

The present application contains subject matter related to that disclosed in Japanese Priority Patent Application JP 2008-191321 filed in the Japan Patent Office on Jul. 24, 2008, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A display device, comprising:
a first photosensor section which includes a light-receiving element on a substrate and detects the intensity of external light in the display region;
a second photosensor section which includes a light-receiving element on the substrate and has a light-shielding film disposed in the optical path to the light-receiving element; and
a signal processing section adapted to perform signal processing to determine the difference in detection signal between the first and second photosensor sections, wherein
the light-shielding film is formed in the same layer as that on the substrate having a light-shielding function so as to be associated with the light-receiving element of the second photosensor section.

2. The display device of claim 1, wherein
the light-receiving element of the second photosensor section is formed with a thin film transistor or PIN diode,
the light-receiving element has its electrodes connected to an overlying wiring layer, and
the light-shielding film is formed in the same layer and with the same material as the overlying wiring layer.

3. The display device of claim 2, comprising:
a backlight adapted to irradiate display light on the display region, wherein
the gate electrode of the thin film transistor or PIN diode is formed closer to the backlight than the light-receiving portion of the light-receiving element and has a light-shielding function.

4. The display device of claim 2, wherein
the surface luminance of the display region is variable, and
the signal processing section changes the surface luminance of the display section according to the result of signal processing adapted to determine the difference in detection signal between the first and second photosensor sections.

5. The display device of claim 4, comprising:
a backlight adapted to irradiate display light on the display region, wherein
the signal processing section controls the level of display light from the backlight.

6. The display device of claim 1, wherein
the first photosensor section can detect light reflected from an object, and
the signal processing section outputs a signal to indicate whether there is any object in front of the first photosensor section according to the result of signal processing adapted to determine the difference in detection signal between the first and second photosensor sections.

7. Electronic equipment having a display device, the display device, comprising:
a first photosensor section which includes a light-receiving element on a substrate and detects the intensity of external light in the display region;
a second photosensor section which includes a light-receiving element on the substrate and has a light-shielding film disposed in the optical path to the light-receiving element; and
a signal processing section adapted to perform signal processing to determine the difference in detection signal between the first and second photosensor sections, wherein
the light-shielding film is formed in the same layer as that on the substrate having a light-shielding function so as to be associated with the light-receiving element of the second photosensor section.

8. A display device, comprising:
first photosensor means which includes a light-receiving element on a substrate and detects the intensity of external light in the display region;
second photosensor means which includes a light-receiving element on the substrate and has a light-shielding film disposed in the optical path to the light-receiving element; and
signal processing means adapted to perform signal processing to determine the difference in detection signal between the first and second photosensor means, wherein
the light-shielding film is formed in the same layer as that on the substrate having a light-shielding function so as to be associated with the light-receiving element of the second photosensor means.

9. Electronic equipment having a display device, the display device, comprising:
first photosensor means which includes a light-receiving element on a substrate and detects the intensity of external light in the display region;
second photosensor means which includes a light-receiving element on the substrate and has a light-shielding film disposed in the optical path to the light-receiving element; and
signal processing means adapted to perform signal processing to determine the difference in detection signal between the first and second photosensor means, wherein
the light-shielding film is formed in the same layer as that on the substrate having a light-shielding function so as to be associated with the light-receiving element of the second photosensor means.
